(19) United States
(12) Patent Application Publication
(10) Pub. No.: US 2026/0015044 A1
(43) Pub. Date: Jan. 15, 2026

(54) STRUCTURE FOR REINFORCING LOWER PORTION OF DASH PANEL OF VEHICLE

(71) Applicants: Hyundai Motor Company, Seoul (KR); Kia Corporation, Seoul (KR)

(72) Inventors: Hong-Soek YOEN, Hwaseong-si (KR); Jun-Hyoung KIM, Hwaseong-si (KR); Min-Cheol KIM, Hwaseong-si (KR)

(73) Assignees: Hyundai Motor Company, Seoul (KR); Kia Corporation, Seoul (KR)

(21) Appl. No.: 18/951,960

(22) Filed: Nov. 19, 2024

(30) Foreign Application Priority Data
Jul. 15, 2024 (KR) 10-2024-0093026

(51) Int. Cl. B62D 25/14; B60R 16/04; H01M 50/242; H01M 50/249

(52) U.S. Cl. CPC B62D 25/145; B60R 16/04; H01M 50/242; H01M 50/249; H01M 2220/20

(57) ABSTRACT

A structure for reinforcing a lower portion of a dash panel of a vehicle, which reinforces the rigidity of the lower portion of the dash panel that partitions an engine compartment and a passenger compartment of the vehicle, preventing a sub-frame from hitting a battery in the event of a collision, includes a dash panel provided at a front end portion of a cabin room in the vehicle in a width direction of the vehicle, a dash center cross upper member including an upper end portion connected to the front of the dash panel and extending downwardly from the upper end portion to a lower portion thereof at an interval from the dash panel, and a dash center cross lower member including a front end portion connected to the dash center cross upper member and a rear end portion connected to a lower end portion of the dash panel, in which the dash panel, the dash center cross upper member, and the dash center cross lower member form a closed cross section.

### CROSS-REFERENCE TO RELATED APPLICATION

The present application claims priority to Korean Patent Application No. 10-2024-0093026, filed on Jul. 15, 2024, the entire contents of which is incorporated herein for all purposes by this reference.

### BACKGROUND OF THE PRESENT DISCLOSURE

### Field of the Present Disclosure

The present disclosure relates to a structure for reinforcing a lower portion of a dash panel of a vehicle, which reinforces the rigidity of the lower portion of the dash panel that partitions an engine compartment and a passenger compartment of the vehicle, preventing a sub-frame from hitting a battery in the event of a collision.

### Description of Related Art

With the electrification of vehicles, the spread of electric vehicles is expanding.

Since the electric vehicle does not adopt an engine, a space called as an engine compartment is reduced to secure a space in which a battery is mounted.

As one method of increasing a traveling distance of the electric vehicle, the increased capacity of the battery is applied. For example, as shown in FIG. 1, an auxiliary battery 120 is additionally applied to a main battery 110 of the vehicle 100 to increase the capacity of the battery, increasing the traveling distance.

However, the weight of the vehicle needs to be increased to increase the capacity of the battery, and to secure the space in which the battery is mounted, a front end portion of the battery 110 needs to be located as far forward as possible on the floor of the vehicle.

In the present way, due to the reduction in the engine compartment and the increase in the battery, it is not easy to adopt a structure for absorbing or transferring a collision load to the rear in the event of a collision.

Therefore, in the event of a frontal collision, there are problems that a sub-frame located at the bottom of the engine compartment is pushed by the collision load to hit the battery, causing damage to the battery and the damage to the battery becomes the main cause of a battery fire.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a structure for reinforcing a lower portion of a dash panel of a vehicle, which reinforces the rigidity of the lower portion of the dash panel to prevent a sub-frame from hitting a battery in the event of a collision and prevents the sub-frame from hitting the battery even when the sub-frame is pushed to the battery side thereof.

A structure for reinforcing a lower portion of a dash panel of a vehicle includes a dash panel provided at a front end portion of a cabin room in the vehicle in a width direction of the vehicle, a dash center cross upper member including an upper end portion connected to the front of the dash panel and extending downwardly from the upper end portion to a lower portion thereof at an interval from the dash panel, and a dash center cross lower member including a front end portion connected to the dash center cross upper member and a rear end portion connected to a lower end portion of the dash panel, wherein the dash panel, the dash center cross upper member, and the dash center cross lower member form a closed cross section.

The structure further includes a dash tunnel member connected to the dash center cross lower member and forming another closed cross section with the dash center cross lower member.

The dash center cross lower member is formed with a sub-frame mounting portion which is formed to be convex downwardly from the dash center cross lower member and to which an insertion portion formed at a rear end portion of a sub-frame of the vehicle is connected.

A front side member connecting portion extending from a side end portion of the dash center cross lower member and connected to a bottom surface of a front side member of the vehicle is formed.

A support bracket disposed in a longitudinal direction of the vehicle is provided inside the dash tunnel member.

The support bracket includes a perimeter coming into contact with a bottom surface of the dash center cross lower member and an internal surface of the dash tunnel member.

A battery protector connected to a bottom surface of the dash tunnel member and located at a front of a battery of the vehicle is connected.

The insertion portion of the sub-frame of the vehicle is connected to the battery protector.

The sub-frame mounting portion formed to be convex downward is formed on the dash center cross lower member, an accommodating portion to which the insertion portion is connected is formed in a portion of an upper surface of the battery protector, and the sub-frame mounting portion and the insertion portion are connected to the accommodating portion.

A front surface of the battery protector is formed as an inclined surface that becomes downward toward a rear of the vehicle.

A rib is formed inside the battery protector.

The battery protector is manufactured by extrusion or casting.

A first reinforcing portion is formed to be convex downwardly from the dash panel behind the dash tunnel member.

A second reinforcing portion protruding upwards from the battery protector and located between the dash tunnel member and the first reinforcing portion is formed.

According to the structure for reinforcing a lower portion of a dash panel of a vehicle of the present disclosure including the above configuration, it is possible to reinforce the rigidity of the lower portion of the dash panel by the reinforcing structure formed by a plurality of closed cross sections on the lower portion of the dash panel, protecting the cabin room in the event of a collision to reduce the passenger's injury.

Furthermore, since the battery protector at the front of the battery is provided to move the sub-frame downwardly from the battery when the sub-frame is pushed in the event of a collision, it is possible to prevent the sub-frame from hitting the battery.

Therefore, it is possible to prevent the passenger's injury and prevent the fire of the battery due to the damage to the battery.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a side view showing an example in which a battery is mounted in a vehicle according to the related art.

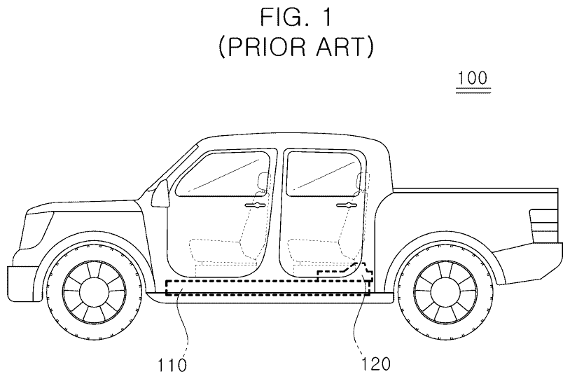

FIG. 2 is a perspective view showing a front body structure of a vehicle to which a structure for reinforcing a lower portion of a dash panel of the vehicle according to an exemplary embodiment of the present disclosure is applied.

FIG. 3 is a side cross-sectional view showing the structure for reinforcing the lower portion of the dash panel of the vehicle according to an exemplary embodiment of the present disclosure.

FIG. 4 is a bottom perspective view showing the structure for reinforcing the lower portion of the dash panel of the vehicle according to an exemplary embodiment of the present disclosure.

FIG. 5 is a bottom view showing the structure for reinforcing the lower portion of the dash panel of the vehicle according to an exemplary embodiment of the present disclosure.

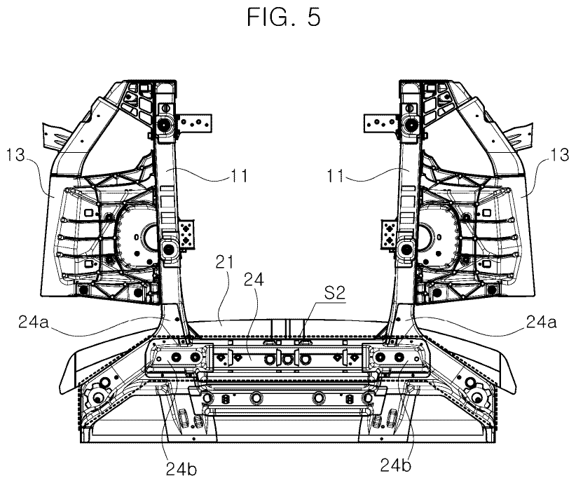

FIG. 6 is a side cross-sectional view showing the behavior of a sub-frame in the event of a collision according to the structure for reinforcing the lower portion of the dash panel of the vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a structure for reinforcing a lower portion of a dash panel of a vehicle according to an exemplary embodiment of the present disclosure will be described in detail with reference to the accompanying drawings.

The structure for reinforcing the lower portion of the dash panel of the vehicle according to an exemplary embodiment of the present disclosure includes a dash panel 21 provided at a front end portion of a cabin room of the vehicle in a width direction of the vehicle, a dash center cross upper member 22 including an upper end portion connected to the front of the dash panel 21 and extending downwardly from the upper end portion to a lower portion thereof at an interval from the dash panel 21, and a dash center cross lower member 23 including a front end portion connected to the dash center cross upper member 22 and a rear end portion connected to a lower end portion of the dash panel 21, in which the dash panel 21, the dash center cross upper member 22, and the dash center cross lower member 23 form a closed cross section.

Since the structure for reinforcing the lower portion of the dash panel of the vehicle according to an exemplary embodiment of the present disclosure is preferably applied to an electric vehicle, the vehicle is preferably an electric vehicle.

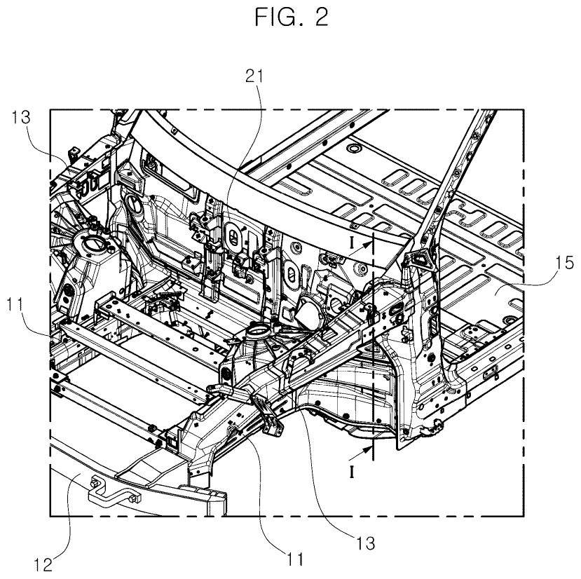

FIG. 2 shows an example of the front body structure of the vehicle. A front side member 11 is disposed in the longitudinal direction of the vehicle, a front back beam 12 on which a bumper of the vehicle is mounted is provided at a front end portion of the front side member 11, a fender apron 13 is disposed above the front side member 11, and the dash panel 21 is disposed at a rear end portion of the front side member 11.

The dash panel 21 is provided at the front of the cabin room of the vehicle in the width direction of the vehicle. The dash panel 21 partitions the so-called engine compartment and the cabin room. Since the engine is not adopted in the electric vehicle, the engine compartment is sometimes called a power electric (PE) room instead. The dash panel 21 includes an upper end portion connected to a cowl panel or the like and a lower end portion connected to a floor panel 15 of the vehicle.

In an exemplary embodiment of the present disclosure, a plurality of closed cross sections forming a hollow structure in the width direction of the vehicle are formed on the lower portion or under the dash panel 21, reinforcing the rigidity of the lower portion of the dash panel 21 and protecting the battery 110 mounted in the vehicle.

The dash center cross upper member 22 includes an upper end portion connected to the front of the dash panel 21 and extends downwardly from the upper end portion to a lower portion thereof at an interval from the dash panel 21. In the height direction of the vehicle, the upper end portion of the dash center cross upper member 22 is connected to the dash panel 21 and an interval is formed from the dash panel 21 downwardly from the upper end portion to the lower portion thereof. To form the interval from the dash panel 21, the dash center cross upper member 22 is formed to extend a predetermined distance from the dash panel 21 to the front of the vehicle and then extend downwardly from the vehicle.

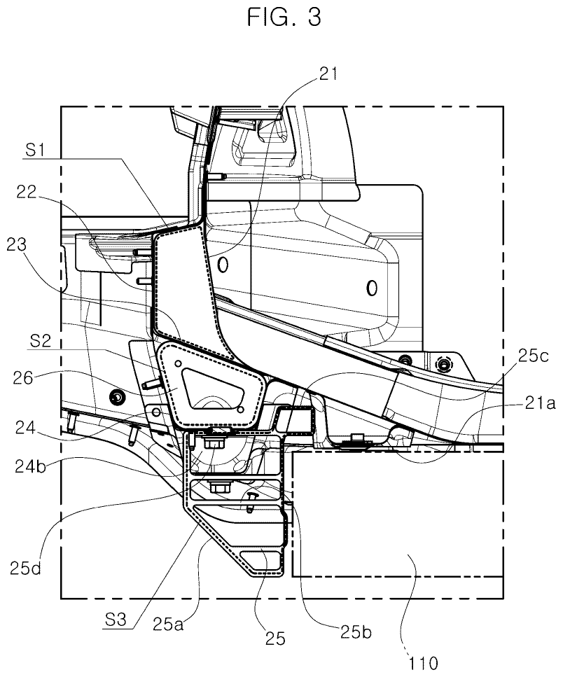

The dash center cross lower member 23 includes a front end portion connected to the dash center cross upper member 22 and a rear end portion connected to the lower end portion of the dash panel 21. The dash center cross upper member 22 and the dash center cross lower member 23 are also formed in the width direction of the vehicle like the dash panel 21, and the dash center cross lower member 23 connects the lower end portion of the dash center cross upper member 22 and the dash panel 21 that are spaced apart from each other to form a closed cross section formed by the dash panel 21, the dash center cross upper member 22, and the dash center cross lower member 23 (see S1 of FIG. 3). The closed cross section is formed in the width direction of the vehicle so that the dash panel 21, the dash center cross upper member 22, and the dash center cross lower member 23 that form the closed cross section function as a single structure.

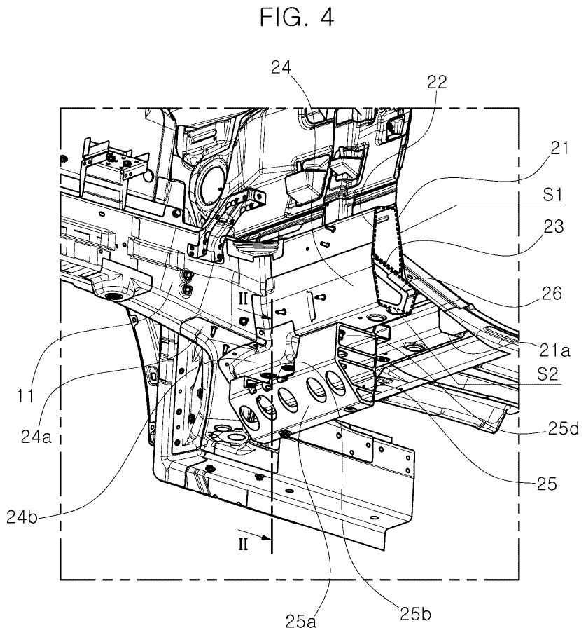

A dash tunnel member 24 is formed to include a downward concave cross section and connected to the dash center cross lower member 23. The dash tunnel member 24 is also formed in the width of the vehicle and connected to the dash center cross lower member 23 to form another closed cross section (see S2 in FIG. 3). Therefore, as shown in FIG. 4, the dash tunnel member 24 connects both end portions of the vehicle and the cross section thereof forms a tunnel structure, additionally reinforcing the rigidity of the lower portion of the dash panel 21.

A front side member connecting portion 24a extending from the side end portion of the dash center cross lower member 23 is formed at a side end portion of the dash tunnel member 24. The front side member connecting portion 24a is connected to a bottom surface of the front side member 11 of the vehicle to connect the dash tunnel member 24 to the front side member 11.

Furthermore, the dash tunnel member 24 is formed with a sub-frame mounting portion 24b convexly formed downwardly from the dash center cross lower member 23. A rear end portion of the sub-frame 14 of the vehicle is connected to the sub-frame mounting portion 24b. The sub-frame mounting portion 24b is connected to the rear end portion of the sub-frame 14 together with the battery protector 25 described below to support the sub-frame 14.

A support bracket 26 disposed in the longitudinal direction of the vehicle is provided inside the dash tunnel member 24. An upper surface of the support bracket 26 inside the dash tunnel member 24 comes into contact with a bottom surface of the dash center cross lower member 23, and the remaining circumference comes into contact with an internal surface of the dash tunnel member 24. By arranging the support brackets 26 at an interval in the width direction of the vehicle inside the dash tunnel member 24, it is possible to reinforce the rigidity of the dash tunnel member 24 in the longitudinal direction of the vehicle.

The battery protector 25 is connected to the bottom surface of the dash tunnel member 24 using a fastening bolt 25d or the like and located in front of the battery of the vehicle. Since the battery protector 25 forms a hollow structure, an additional closed cross section structure S3 is formed under the closed cross section shown as S2 (see S3 of FIG. 3).

In the present way, since the closed cross sections shown as S1, S2, and S3 of FIG. 3 are provided on the lower portion of the dash panel in the height direction of the vehicle, it is possible to reinforce the rigidity of the lower portion of the dash panel 21.

Since the battery protector 25 includes a hollow structure, the battery protector 25 includes a cross section of a constant shape in the width direction of the vehicle by extrusion or casting.

A rib is formed inside the battery protector 25 to reinforce the rigidity of the battery protector 25.

The battery protector 25 may be formed to include a predetermined length in the width direction of the vehicle and disposed at an interval in the width direction of the vehicle. Usually, since the rear end portion of the sub-frame 14 of the vehicle is connected to the floor panel 15 at both left and right sides, the battery protector 25 may also be disposed at both left and right sides correspondingly. Of course, the battery protector 25 may also be disposed in an area not connected to the sub-frame 14 to protect the battery 110.

A front surface of the battery protector 25 is formed as an inclined surface 25a. Since the front surface of the battery protector 25 is formed as the inclined surface 25a that becomes downward toward the rear of the vehicle, when the sub-frame 14 is broken due to a frontal collision, the sub-frame 14 is guided to move along the inclined surface 25a. Therefore, the sub-frame 14 pushed by the collision load is prevented from pushing the battery 110 to the rear of the vehicle, or the sub-frame 14 broken by the collision load is prevented from hitting the battery 110.

The battery protector 25 is connected to the rear end portion of the sub-frame 14 together with the sub-frame mounting portion 24b. The battery protector 25 is formed with an accommodating portion 25b which may accommodate the sub-frame mounting portion 24b formed to be convex downward on a portion of the upper surface thereof and an insertion portion 14a formed at the rear end portion of the sub-frame 14. The rear end portion of the sub-frame 14 is connected so that the insertion portion 14a is inserted between the sub-frame mounting portion 24b and the battery protector 25 inside the accommodating portion 25b.

A second reinforcing portion 25c for reinforcing the rigidity of the battery protector 25 is formed on an upper portion of the battery protector 25. The dash panel 21 is formed with a first reinforcing portion 21a which is formed to be convex downward behind the dash tunnel member 24. The first reinforcing portion 21a additionally forms a closed cross section structure behind the dash tunnel member 24. The second reinforcing portion 25c of the battery protector 25 protrudes upwards from the battery protector 25 and is located between the dash tunnel member 24 and the first reinforcing portion 21a, reinforcing the rigidity of the battery protector 25.

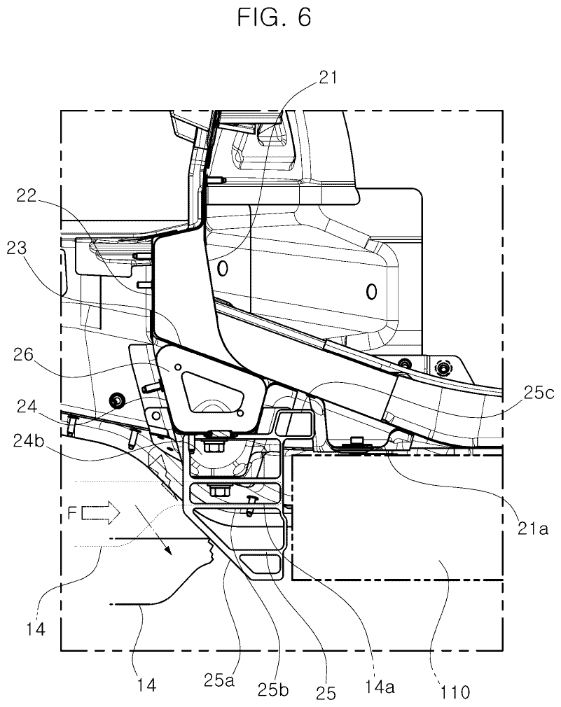

FIG. 6 shows the behavior of the sub-frame 14 in the event of a collision of the vehicle. When a frontal collision occurs, the sub-frame 14 supporting the internal electrical system of the vehicle in the engine compartment is pushed to the rear of the vehicle by the collision load.

The sub-frame 14 is broken at a portion adjacent to the insertion portion 14a due to the collision load.

In the present way, when the portion of the sub-frame 14 connected to the dash tunnel member 24 and the battery protector 25 is broken, the sub-frame 14 tries to continuously move to the rear of the vehicle. At the instant time, the sub-frame 14 comes into contact with the inclined surface 25a of the battery protector 25 and moves along the inclined surface 25a.

Therefore, even when the sub-frame 14 is pushed to the rear of the vehicle by the collision load, the sub-frame 14 may move to the rear of the vehicle downwardly from the battery 110, preventing the sub-frame 14 from hitting the battery 110.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A structure for reinforcing a lower portion of a dash panel of a vehicle, the structure comprising:
a dash panel provided at a front end portion of a cabin room in the vehicle in a width direction of the vehicle;
a dash center cross upper member including an upper end portion connected to a front of the dash panel and extending downwardly from the upper end portion to a lower portion of the dash center cross upper member at an interval from the dash panel; and
a dash center cross lower member including a front end portion connected to the dash center cross upper member and a rear end portion connected to a lower end portion of the dash panel,
wherein the dash panel, the dash center cross upper member, and the dash center cross lower member form a first closed cross section.

2. The structure of claim 1, wherein the dash center cross lower member connects the lower end portion of the dash center cross upper member and the dash panel that are spaced apart from each other to form the first closed cross section formed by the dash panel, the dash center cross upper member, and the dash center cross lower member.

3. The structure of claim 1, further including a dash tunnel member connected to the dash center cross lower member and forming a second closed cross section with the dash center cross lower member.

4. The structure of claim 3, wherein the dash tunnel member includes a downward concave cross section.

5. The structure of claim 3, further including a sub-frame mounting portion, wherein the dash center cross lower member is formed with the sub-frame mounting portion which is formed to be convex downwardly from the dash center cross lower member and to which an insertion portion formed at a rear end portion of a sub-frame of the vehicle is connected.

6. The structure of claim 5, further including a front side member connecting portion extending from a side end portion of the dash center cross lower member and connected to a bottom surface of a front side member of the vehicle.

7. The structure of claim 5, wherein a rear end portion of the sub-frame of the vehicle is connected to the sub-frame mounting portion and the sub-frame mounting portion is connected to the rear end portion of the sub-frame with a battery protector to support the sub-frame.

8. The structure of claim 3, further including a support bracket disposed in a longitudinal direction of the vehicle and provided inside the dash tunnel member.

9. The structure of claim 8, wherein the support bracket includes a perimeter coming into contact with a bottom surface of the dash center cross lower member and an internal surface of the dash tunnel member.

10. The structure of claim 8, further including a battery protector connected to a bottom surface of the dash tunnel member and located at a front of a battery of the vehicle.

11. The structure of claim 10, wherein the battery protector is formed in a hollow structure to form a third closed cross section under the second closed cross section.

12. The structure of claim 10, wherein an insertion portion of a sub-frame of the vehicle is connected to the battery protector.

13. The structure of claim 12,
wherein a sub-frame mounting portion formed to be convex downward is formed on the dash center cross lower member,
wherein an accommodating portion to which the insertion portion is connected is formed in a portion of an upper surface of the battery protector to accommodate the sub-frame mounting portion, and
wherein the sub-frame mounting portion and the insertion portion are connected to the accommodating portion.

14. The structure of claim 12, wherein the insertion portion is inserted between the sub-frame mounting portion and the battery protector inside the accommodating portion.

15. The structure of claim 10, wherein a front surface of the battery protector is formed as an inclined surface that becomes downward toward a rear of the vehicle.

16. The structure of claim 10, wherein a rib is formed inside the battery protector.

17. The structure of claim 10, wherein the battery protector is manufactured by extrusion or casting.

18. The structure of claim 10, wherein a first reinforcing portion is formed to be convex downwardly from the dash panel behind the dash tunnel member.

19. The structure of claim 18, further including a second reinforcing portion protruding upwards from the battery protector and located between the dash tunnel member and the first reinforcing portion.
